(19) United States
(12) Patent Application Publication
(10) Pub. No.: US 2005/0186999 A1
(43) Pub. Date: Aug. 25, 2005

(54) Video bowling games

(76) Inventors: Ralph William Melgosa, Algonquin, IL (US); Scott Alan Haag, Arlington Heights, IL (US); James Zielinski, Gilberts, IL (US); Lawrence J. Hodgson, Kildeer, IL (US)

Correspondence Address: WELSH & KATZ, LTD, 120 S RIVERSIDE PLAZA, 22ND FLOOR, CHICAGO, IL, 60606, US

(21) Appl. No.: 11/042,261

(22) Filed: Jan. 25, 2005

Related U.S. Application Data
(60) Provisional application No. 60/539,285, filed on Jan. 26, 2004.

(51) Int. Cl. G06F 17/00

(52) U.S. Cl. 463/2

(57) ABSTRACT

A video bowling game incorporates a multi-dimensional ball control transducer, such as a track ball, to enable a player to specify travel and velocity parameters. A two-dimensional bowler is presented on a display. The transducer can be used to control both the backswing and delivery of the ball onto a simulated lane toward the pins displayed at the far end thereof.

### CROSS REFERENCE TO RELATED APPLICATION

This application claims the benefit of the filing date of U.S. Provisional Application No. 60/539,285 filed Jan. 26, 2004.

### FIELD OF THE INVENTION

The invention pertains to video bowling games. More particularly, the invention pertains to such games which provide a realistic game play experience.

### BACKGROUND

A variety of video games are known and present various levels of game play performance. The performance levels range from games suitable to be run on personal computers which are to be controlled using a standard keyboard or a joy stick-type inputs to specialize game play systems for home or casual use which provide a more sophisticated and extensive gaming experience to arcade games which, on a pay per play basis, provide an even more realistic play experience.

Representative of arcade-type games is the GOLDEN TEE brand family of video golf games. Such games provide an interactive golfing experience which supports handicapping, tournament as well as league play. The GOLDEN TEE brand family of golf video games has been widely disseminated and successful, at least in part, because of its realistic presentation and player satisfaction.

Some known games, such as the GOLDEN TEE brand game family, incorporate a track ball as a player input transducer. Such transducers provide not only position information, but also direction and velocity information to the game control circuitry.

Not all potential players have an interest in or skill appropriate for playing a golf game. There continues to be a need of other types of quality interactive sports games which enable players to promote and exercise their particular skills in connection with different types of individual sports activities. Preferably, such games will reflect the complexity and excitement of the respective activity so that the participant(s) will have an opportunity to seriously exercise his or her skills in ways that are both rewarding and stimulating.

### BRIEF DESCRIPTION OF THE DRAWINGS

FIG. 1 is a block diagram of a system in accordance with the invention;

FIG. 1A illustrates an exemplary control panel usable with video games in accordance with FIG. 1;

FIG. 2 illustrates an initial game play flow diagram;

FIGS. 3A-3F taken together, illustrate various views of a bowler located at a proximal end of a lane with a group of bowling pins located at a distal end thereof;

FIG. 4 is a flow diagram of processing where the player has lobbed a ball;

FIG. 5 illustrates one of a group of images associated with a lobbed ball;

FIG. 6 is a flow diagram illustrating ball throw processing;

FIGS. 7A-7C are images illustrating various aspects of a ball throw display;

FIG. 8 is a flow diagram of throw calculation processing;

FIG. 9 is a flow diagram of processing as a ball traverses a lane toward the pins taking into account the lane oil profile;

FIGS. 10A is a top plan view that illustrates the effect of lane oil profile on ball performance;

FIGS. 10B-10K taken together are a sequence of displayed images of a ball rolling on a lane in accordance with the processing of FIG. 9; and

FIG. 11A-11I, taken together illustrate a particular player selectable game sequence.

### DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

A video bowling game which embodies the invention enables a player to participate in realistic tournaments, contests, and operator run leagues. Such games will enable players to create skill rankings, play in tournaments and leagues, and compare online statistics.

A disclosed embodiment of the game includes a graphical display in combination with a control panel and control electronics. The control panel can include a track ball which provides realistic game play performance. Other multi-dimensional input transducers such as a joy stick, mouse or the like could also be used.

The control electronics can include one or more programmed processors, and pre-stored control programs. It can also include a wired or wireless port to an external server to support league play across a plurality of game machines.

In an arcade-type embodiment, the game begins when the player establishes a credit. For example, the player can insert a coin, bill or credit card. The first screen can display a selection region for number of players and prompt for an additional credit, if necessary. The next screen can enable a player(s) to select one of regular bowling, team bowling, league play or tournament play. The type(s) of play that is (are) available can be pre-set by the game operator.

Transducer control can be implemented in conjunction with a visible human bowler presented on the display. The bowler can be represented as a 2D, or 3D bowler with numerous frames of animation.

In a disclosed embodiment, the bowler can initially be displayed near the front or proximal end of the lane, ready to deliver a ball. Rolling back or down on the track ball will bring the bowler's arm back; rolling forward will instigate the follow through and release of a simulated ball. Hook/curve controls can also be incorporated to allow the players to control the direction and severity of break.

The force needed to cause the ball to move along the lane at a desired velocity can be based on or derived from the speed of movement of the track ball. A faster moving track ball will result in a faster ball down the lane. In bowling, a faster ball can often lead to splits. Therefore, pinpoint control of the ball by the player is preferred for a quality game play experience.

In a disclosed embodiment, pins will be graphically presented at a distal end of the lane. The pins will preferably be displayed substantially three-dimensionally. Collisions between the ball and pins as well as between pins will preferably be presented substantially three dimensionally to provide a realistic portrayal of pin action.

Multiple camera angles can optionally be incorporated to allow the player to see the lane from different perspectives. The cameras can be selected using a button press after release of the ball. These can include the following exemplary perspectives:
High angle forward view;
¾ side view;
Player's end of lane view;
Behind the pins view;
Behind the ball view;
TV style zoom view.

In one embodiment, if the player selects Team Bowling, the game will enable the players to divide into two teams. Team bowling provides a venue for “alternate playing incentives”. Team bowling can be selected if there is an even number of players. Particularly for in-house league play, an 8 player game can be provided. The visual difference for team bowling can include the use of a second lane.

After a player from team #1 bowls a frame, the camera can be moved sideways to enable the next player from team #2 to bowl on the next lane. This along with a different shirt color will help the player(s) to remember which bowler to control by keeping the teams isolated to their assigned lanes. It also makes a discernible visual difference between regular bowling and team bowling. The player scores along with the total pins for the team can be displayed after each frame.

In another embodiment, for extra money or credits the player can play in a league game. The game can keep track of bowling statistics. An overview can be displayed before each game and detailed statistics can be provided via a website access.

Various optional features can be provided for a league bowling tournament. Skill rankings can be determined by playing league play games. League bowlers can be awarded a unique “premium ball” based on overall points. League bowlers can also earn a “High Roller” shirt based on their average over their last ten games. League bowlers can also be given additional options not available in standard play. The options can include:

Additional male & female bowlers;
Left-handed bowler (right handed is the default);
Additional bowling alleys with varying lane conditions (oil patterns).

Various forms of ball control come within the spirit and scope of the invention. For example, in a disclosed embodiment, after deciding on the optimum shot, the player can pull the track ball back (away from the screen) in the desired direction, and push in a forward direction (towards the screen) in order to define the path of the ball.

Once the track ball has been pushed forward, the player's onscreen avatar extends his or her arm and the ball is released down the alley. The direction on the pull back and push forward of the track ball can control the degree of hook or curved placed on the ball.

The velocity of the ball can be established not only by how hard the track ball is pushed forward, but also by the amount of force placed on the track ball hardware. Ball weight is a recognized bowling parameter. The weight of the ball also affects velocity. Ball weights of 12-16 lbs. can be chosen by the player.

With an equal amount of force applied to the track ball, the lighter ball will move faster down the lane, while the heavier ball will move slower. The amount of break (the subsequent hooking or curving action of the bowling ball) can be governed by the movement of the track ball, the weight of the ball itself, and the forced applied on the track ball.

In another disclosed embodiment, the degree of break may also be governed by the pattern of oil placed on the lane. Depending on where patches of oil are and are not located, the ball will respond appropriately by sliding and grabbing the alley surface more or less. Those who are skilled in the art of bowling will appreciate that this is the same dynamic present in the physical form of the sport. Success in aiming the bowling ball through the use of hook or curve will be determined by the bowler's ability to judge the proper amount of force and direction given the weight of the ball and the simulated bowling alley's surface.

Various types of games within a bowling sequence can be incorporated into normal play. One such combines a card game with the bowling activity. For each spare or strike made by a player, a card is drawn from a deck. At the end of the game, the best hand wins.

In an alternate form of game-within-a-game, for each strike a player gets, a silver pin is added to a rack of pins. The goal is to fill up ten silver pins in a rack and then go for the silver strike.

If a player plays a series of games, the silver pins can carry over from one game to the next until ten of them are available. If a player makes a “silver strike” by knocking down all the silver pins with one ball, a dynamic animation can be presented. The player can be entered into a special leaderboard. Players can be ranked in this leaderboard by how quickly (how many games/frames) it took to make the “silver strike”.

In yet another form of a game-within-a-game, players can be assigned a random number each time they make a strike. The assigned random numbers can be presented on the display for the player. At the end of the game, a roulette wheel can be spun. The player who has a random number which corresponds to the final location of the ball on the roulette wheel wins. In the event that none of the players win, they can be prompted to carry over the current pot, if any, to the next game.

In another game of skill, as an alternate to straight bowling or league bowling, a player can select from a group of various pin combinations which might be present after the first ball has been rolled, and in the absence of a strike. These combinations can vary between easy, medium and hard.

If the player who has selected the combination makes the shot knocking down all of the pins in the combination, the next player must repeat that selection and shot. A letter is given to each player for every missed shot. A player is eliminated once he/she receives all the letters in the word “HORSE”.

As an alternate to “HORSE”, a “SPARE CHALLENGE” feature can be provided. In this mode, each player can select one of a group of pin combinations, such as would be present after the first ball of a frame has been rolled. The combinations can range from easy, to medium, to hard or challenging.

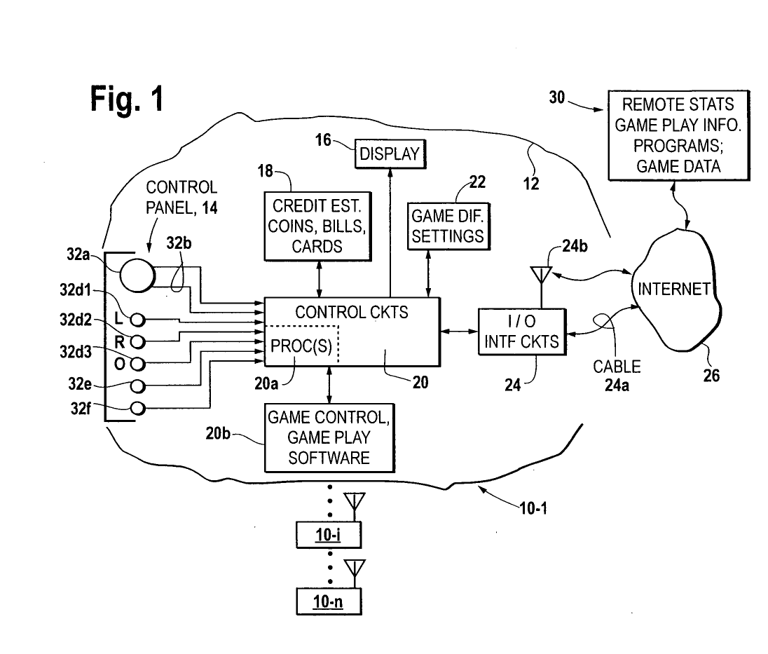

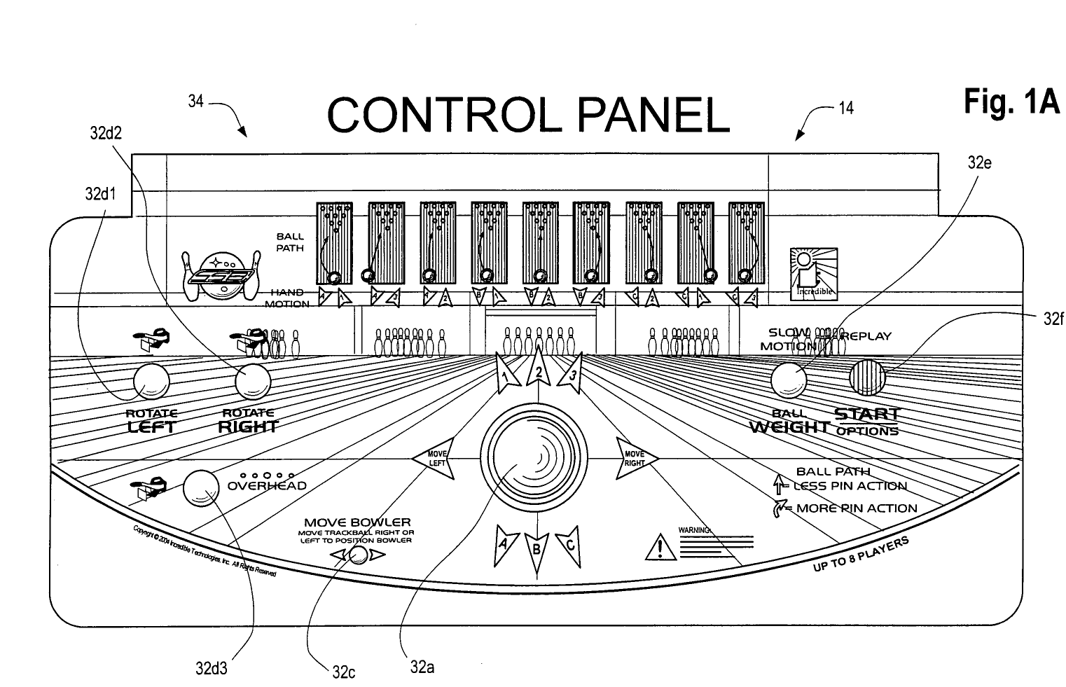

FIG. 1 illustrates a system 10 in accordance with the invention. The system 10 incorporates a plurality of substantially identical video bowling games 10-1, -2 . . . -n. Game 10-1 is representative of the members of the plurality. A description of game 10-1 also applies to other members of the plurality.

The bowling video game 10-1 is carried in a cabinet 12. The cabinet 12 supports a control panel generally indicated at 14, best seen in FIG. 1A. The cabinet 12 also carries a graphical display 16. An optional credit establishing unit 18 which can receive coins, bills or cards can also be carried by the cabinet 12. It will be understood that depending on the particular market of a respective embodiment of the subject video game, the credit establishing unit may or may not be needed.

Control circuitry 20 carried by cabinetry 12 is coupled to signals received from manual inputs on the control panel 14, as well as signals from the credit establishing unit 18. The control circuitry 20 is coupled to display 16 for purposes of providing a variety of at least two dimensional displays as discussed in more detail subsequently.

The control circuitry 20 can include one or more programmable processors 20a which can carry out various game play instructional sequences indicated generally at 20b. Those of skill will understand that the programs or software 20b could be stored in various types of read/write memory including disk drives, semiconductor memory or the like, all without limitation. Additionally, some or all of the software 20b could be stored in a read-only memory or programmable read-only memory, all without limitation. Further, using circuitry discussed subsequently, instructions can be downloaded to the game 10-1 from a remote source as desired.

Game level difficulty such as easy, medium or hard can be manually set by an operator, such as with switch(s) 22 in off-line modes of play. The game play level setting could also be downloaded from a remote site. In other forms of play, including on-line play, all participating games would exhibit the same level of difficulty.

The control circuitry 20 can also be coupled to and in bidirectional communication with input/output interface circuitry 24. The circuitry 24 can communicate with remote sites via a cable connection 24a or wirelessly by an antenna 24b, via a computer controlled network such as intranet or internet 26.

Information, statistics, other data and programs can be stored at one or more remote sites indicated generally at 30. The site 30 can receive data via the network 26 from the games 10-1, -2 . . . -n. Similarly, the site 30 can download statistics, data and/or programs as needed by the network 26 to inspect one of the games such as the game 10-1. One such network based game play system has been disclosed in a previously filed patent application entitled Games With Wireless Communications Capabilities, application Ser. No. 10/935,296 filed Sep. 7, 2004 and assigned to the assignee hereof. That disclosure is incorporated herein by reference.

The control panel 14 includes a multi-dimensionally movable track ball 32a whose signals 32b are coupled to the control circuitry 20. The track ball 32a, as discussed in more detail subsequently, can be used to direct the path and provide velocity information of a bowling ball delivered onto a respective image of a bowling lane. Label 32c indicates that trackball 32a can be used to locate an image of a bowler laterally relative to a respective bowling lane.

A plurality of switches 32d1, d2 and d3 can be used to specify a viewing orientation relative to the respective bowler and lane. Switches 32d1, d2 the rotate left and rotate right switches enable a player to change an angle of delivery of the ball, relative to the pins as bowlers might do on a physical lane. The degree of such rotation, relative to a centerline of the lane can fall in a range of +0-5 degrees.

The control panel 14 carries a ball rate/slow motion switch 32e and a start/replay/options switch 32f. It will be understood that some or all of the noted switch functions could be implemented by virtual switches, light buttons, on the display 16 without departing from the spirit and scope of the present invention. Similarly, the definitions of the various control elements on the panel 14 may be varied within the spirit and scope of the invention. Any and all game settings such as game play fees, or play level such as easy, medium or hard can be set manually at the game by an operator or downloaded from a remote site.

The control panel 14 also carries graphical information 34 which provides player feedback as to the behavior of a respective bowling ball as it travels along the lane in response to backward (toward the arrows A, B, C) or forward (toward the arrows 1, 2, 3) motion provided by a player.

In accordance with embodiments of the invention, one or more players can establish credits at the game 10-1 via the credit establishing unit 18, up to a total of, for example, 8 players. As discussed subsequently, players can elect to engage in a traditional or straight game of bowling, league bowling or tournament play. Additionally, they can engage in various types of bowling-related exercises or activities.

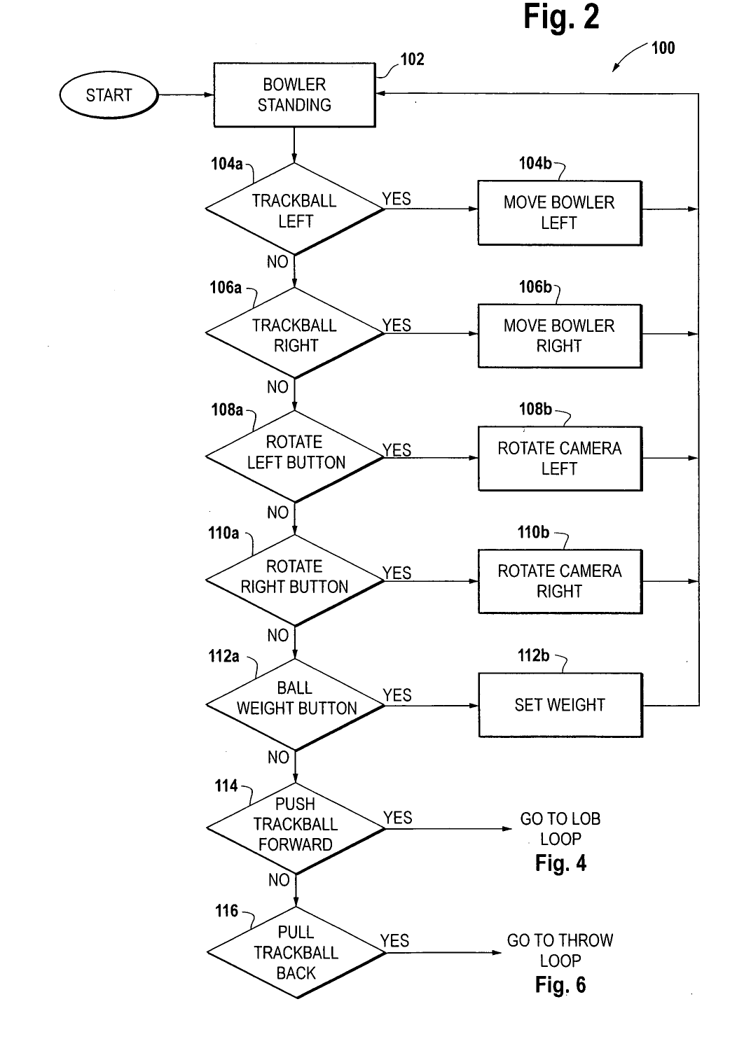

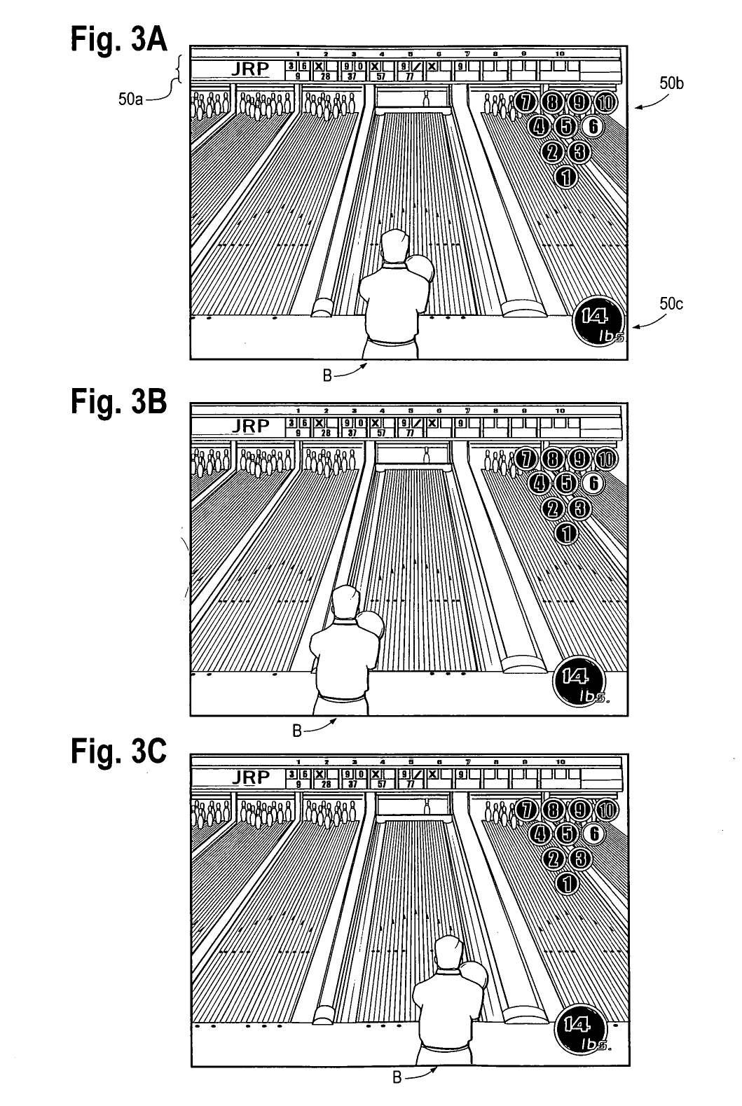

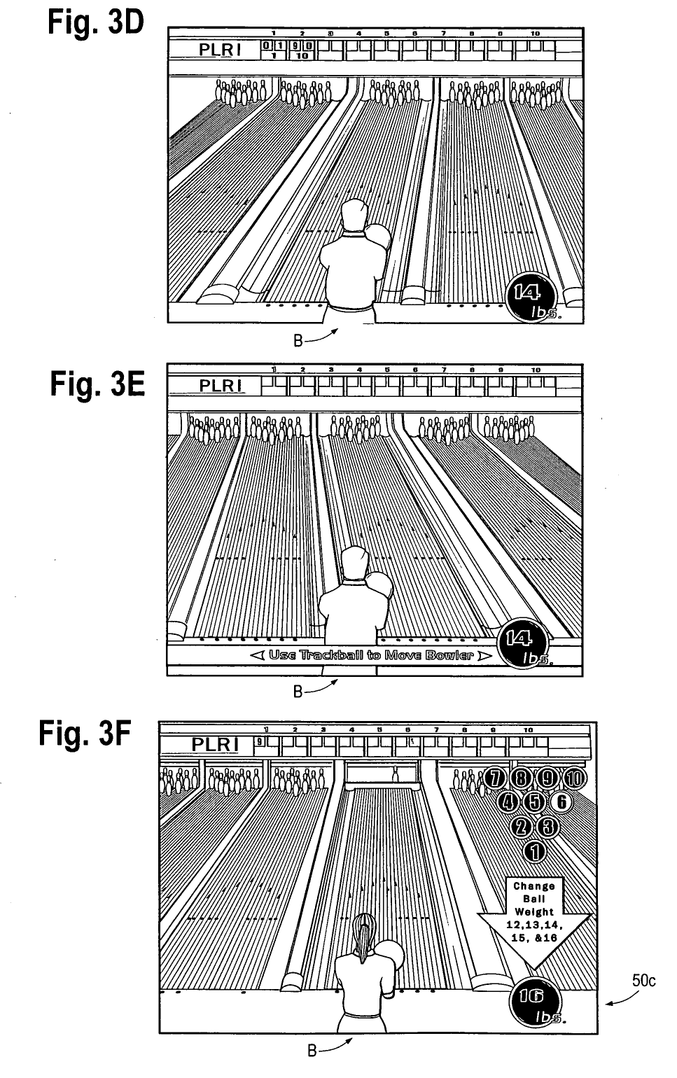

FIG. 2, a flow diagram of processing 100 in combination with the displays of FIGS. 3A-3F, illustrates details of the system 10 prior to the player releasing a bowling ball. In a step 102, a figure of a bowler is displayed, FIG. 3A, at the proximal end of the bowling alley and looking toward the distal end of the alley where a single pin is standing. The display 3A presents, across an upper region thereof, a score line 50a for the player represented by the bowler B. To the right of the display of FIG. 3A, is a top plan view of the remaining pins 50b. In the lower right corner of the display of FIG. 3A is an indicator of pre-selected ball weight 50c.

In steps 104a, b, the bowler B has been moved laterally to the left relative to the lane, see FIG. 3B, by motion of the track ball 32a, as indicated by label 32b.

Steps 106a, b illustrate as on FIG. 3C, the result of moving the track ball to the right, which moves the bowler B to the right relative to the lane. In steps 108a, b, the rotate left button 32d1 has been depressed causing the camera to present the bowler B in the lane as viewed looking to the left. Steps 110a, b illustrate the bowler B located on the left side of the lane and presented with a camera orientation rotated to the right relative to the lane, see FIG. 3E. As described previously, the rotate buttons alter the angle of delivery of the ball relative to a centerline along the alley.

In steps 112a, b the ball weight button 32e has been depressed causing a change of ball weight to appear at the lower right corner of the display 50c. In step 114, if the track ball 32a has been pushed forward, rotated toward numbered arrows 1, 2, 3, the player has indicated that the bowling ball is to be lobbed by the bowler B as illustrated by processing in FIG. 4. If as illustrated in step 116, the player has rotated the track ball 32a back toward arrows A, B, C, the ball is to be delivered to the lane using a traditional underhanded throw or delivery as illustrated by processing in FIG. 6.

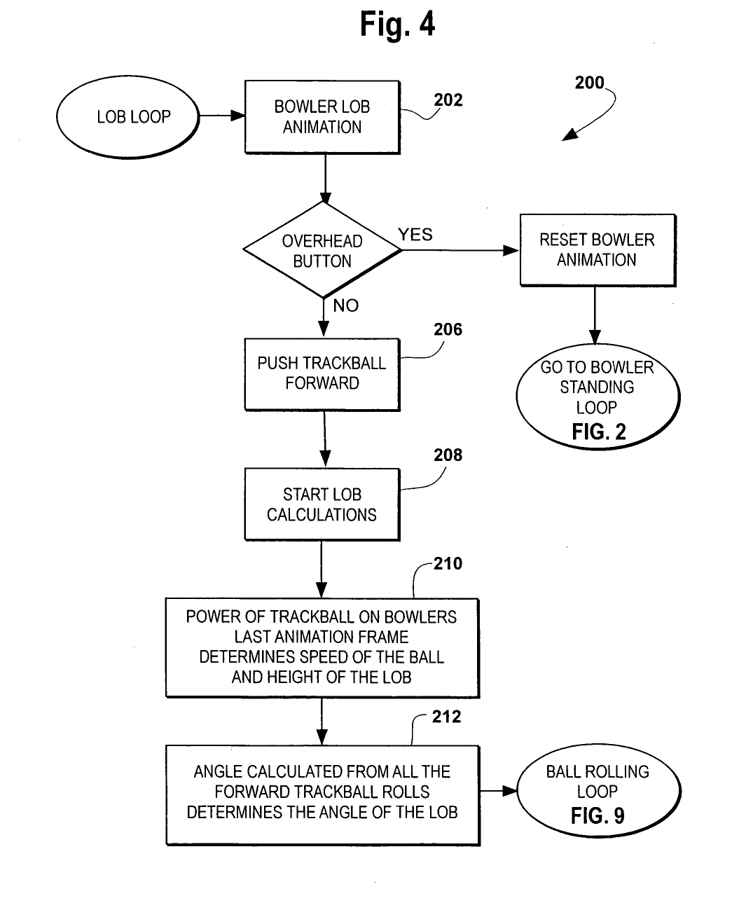

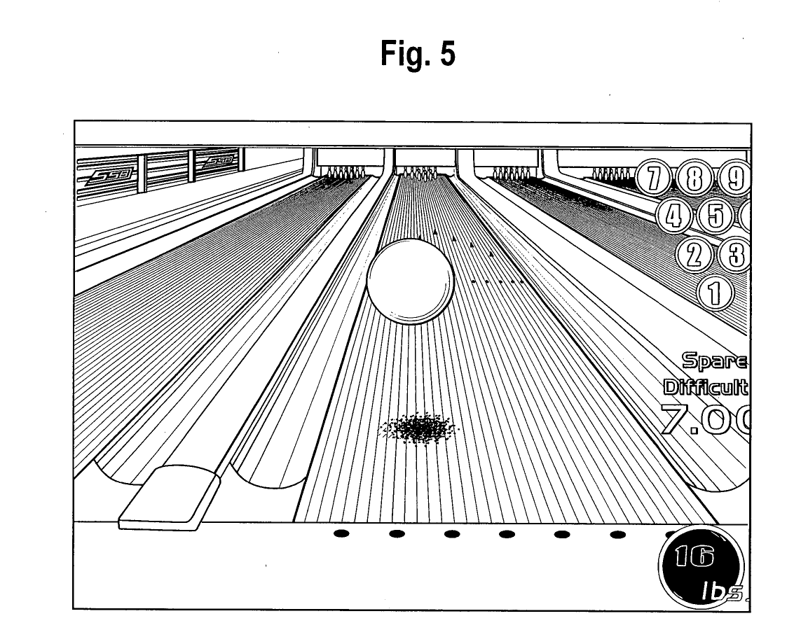

FIG. 4 is a flow diagram of the lob loop processing 200. As a result of pushing the track ball forward, step 114, a dynamic display of Bowler animation frames of the bowler's arm going forward, step 202, will be presented as a sequence of images on display 16. Subsequently as illustrated in FIG. 5, the bowling ball will be displayed as being lobbed down the lane. As the track ball continues to be pushed forward, step 206, control circuitry 20 and related software 20b carry out the necessary calculations to subsequently to produce a dynamic changing display, step 208 as the lobbed bowling ball comes into contact with and travels along the lane.

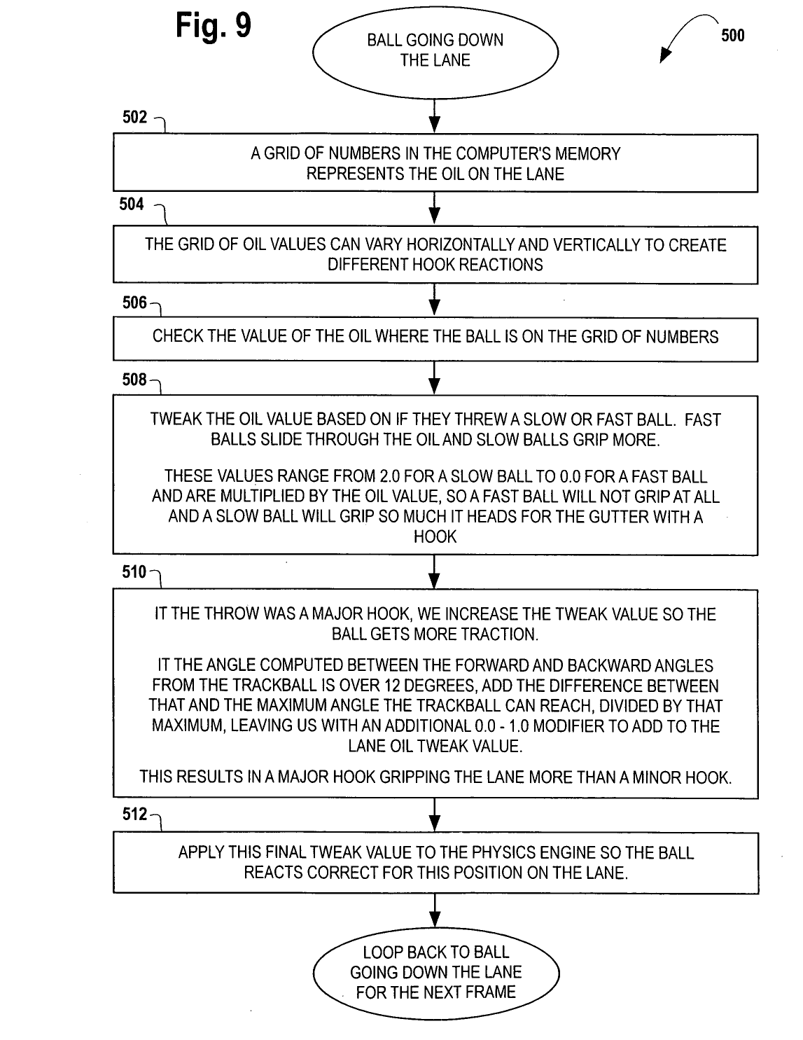

In step 210, the control circuits 20 in combination with software 20b detect from the outputs 32b of the track ball 32a, parameters such as the speed of the ball and the height of the lob to be displayed, FIG. 5. In step 212 the angle at which the track ball 32a has been rolled forward by the player can be established and determines the angle of the lob. Lob processing 200 is completed at the time when the last Bowler animation frame is displayed. At this time the Ball Rolling processing is initiated, best seen in FIG. 9 (discussed subsequently) to present a sequence of images of the ball on the lane.

As a result of the processing of FIG. 9, the ball is displayed traveling along the lane toward the pins. When the ball reaches the distal end of the lane, it rolls into the pins, and, some or all of the pins can be displayed as being knocked down with other pins still standing as in a physical game of bowling.

Those of skill in the art will understand that commercially available physics calculating engines can be used to effect the required processing to produce a realistic animation of the ball coming into contact with, rolling along the lane, and impacting the pins. Represetnative of such packages is software of a type available under the RENDERWARE product line from the Criterion Div. of Electronic Arts. The details of such software are not limitations of the invention.

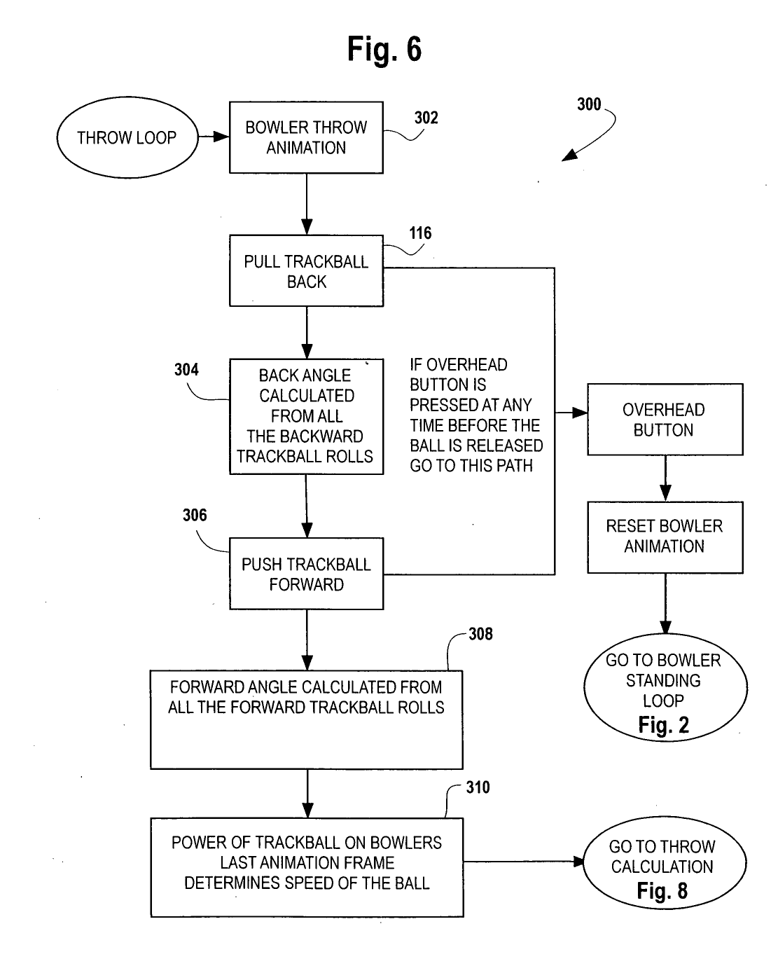

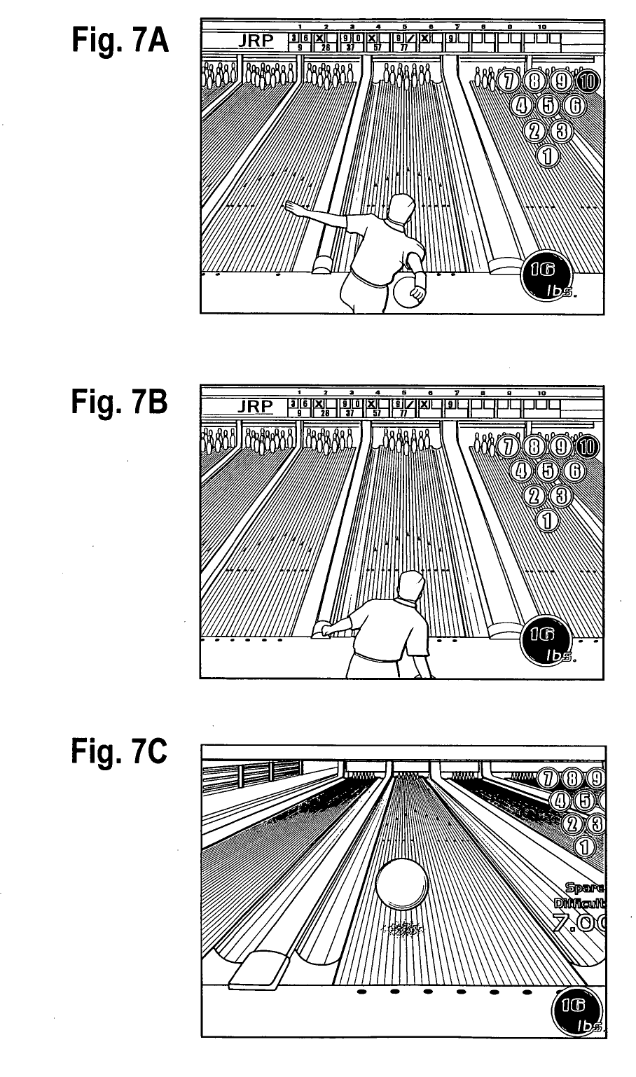

FIG. 6 illustrates a flow diagram 300 of the throw loop processing. A sequence of Bowler thrown animation frames is presented on the display 16, step 302. FIGS. 7A and 7B illustrate various Bowler animation frames presented on display 16. FIG. 7C is a view of ball delivery. FIGS. 7A-7C result from steps of the process 300. Where the track ball 32a has been rotated back or toward the arrows labeled A, B, C, the default right arm of the bowler B holding the bowling ball is also drawn back as illustrated in FIG. 7A. In a step 304, a back angle can be calculated from the signals 32b from the track ball.

As the player then pushes the track ball forward, step 306, information is acquired to determine how the ball is to be delivered onto the lane. A forward angle can be calculated from forward rolling track ball data step 308 along with the velocity of the ball 310 as of the last Bowler animation frame. FIG. 7B illustrates the bowler B swinging the ball forward toward the lane. FIG. 7C illustrates the ball which has been delivered rolling on the lane toward the pins as discussed relative to FIG. 9.

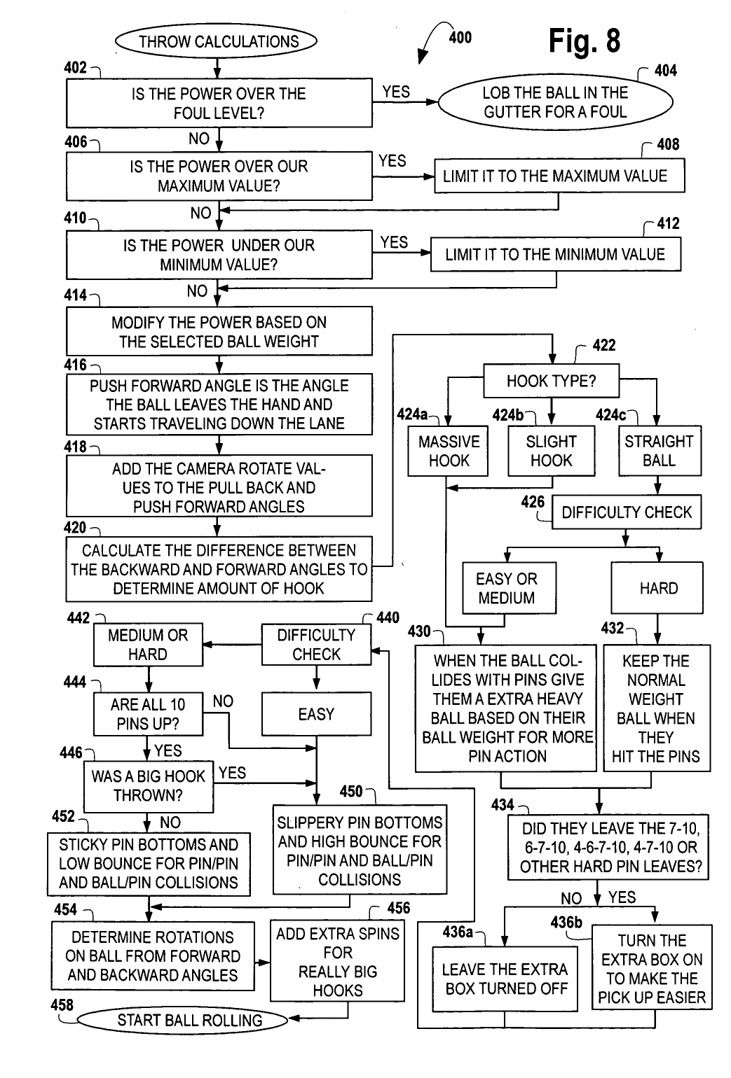

Throw calculation processing associated with the delivery of the ball as a result of pushing the track ball forward, step 306, is illustrated by processing methodology 400 of FIG. 8.

Those of skill will understand that the processing 400 is carried out at the end of forward motion of the track ball 32a and before the ball rolling processing 500, FIG. 9 is initiated.

In an initial step 402, the control circuitry 20 and software 20b determine if the power associated with rotating the track ball 32a is too high. In such an event the ball rolls into the gutter, step 404. If not, in a step 406 the power or force of rotation of the track ball is compared to an acceptable maximum value and if in excess of that is limited to that predetermined maximum value, step 408. In a step 410 the power due to rotation of the track ball is compared to a predetermined minimum value. If less than a predetermined minimum, it is set to the minimum value step 412.

In step 414 the power or velocity of the ball can also be adjusted based on selected ball weight. In step 416 the angle that the ball leaves the hand of the bowler B and starts traveling down the lane is set equal to the push forward angle. In step 418 the camera rotate values are added to the pull back and push forward angles. The amount of hook is determined, step 420 by calculating the difference between the backward and forward angles.

In step 422, a determination is made as to hook type. The step 422 determination is also consistent with the information of graphic 34, best seen on FIG. 1A of the control panel. Representative available types of ball delivery include a massive hook 424a, slight hook 424b and a straight ball 424c.

A difficulty check based on a pre-set game difficulty level for example by the switch(s) 22, is carried out step 426. Based on the results of step 426, where the game difficulty level is set to easy or medium, or in the presence of a ball with a hook, steps 424a, b, in a step 430, ball weight is adjusted and increased to improve pin action. On the other hand where the game difficulty is highest, “hard”, in step 432, ball weight is not adjusted.

In step 434, the difficulty of successfully rolling a spare relative to various difficult pin combinations is assessed. The step 434 always results in a “No” result for the first ball of any frame.

Where a difficult pin combination is present a pickup adjustment can be made to make pickup easier, step 436a. Such adjustments can be effected, as would be understood by those of skill in the art, by establishing, for use by the above noted physics engine, an additional unseen collision structure, such as a box or other shape. The existence of the added collision structure can be provided to the physics engine as a parameter, along with other provided parameters to carry out the collision processing. Otherwise, the pickup adjustment is not made, step 436b. The added collision structure, unseen by the player, provides another element off of which the pin(s) can bounce in response to an impact by the ball.

In a step 440 another difficulty check, as above, is made. If the game play level is medium or hard, step 442 and all 10 pins are standing, step 444, the degree of hook is evaluated step 446. Where the hook is large, pin characteristic parameters are selected, step 450 to produce extensive pin action with a high degree of bounce. Alternately, in step 452, a low bounce pin configuration is selected in combination with sticky pin bottoms.

In step 454 ball rotation is determined from the forward and backward angles associated with the player rotating the track ball 32a along with the camera rotate values. Ball processing can be adjusted, step 456 to add extra spins for large hooks. In step 458, the Ball Rolling processing is initiated, FIG. 9.

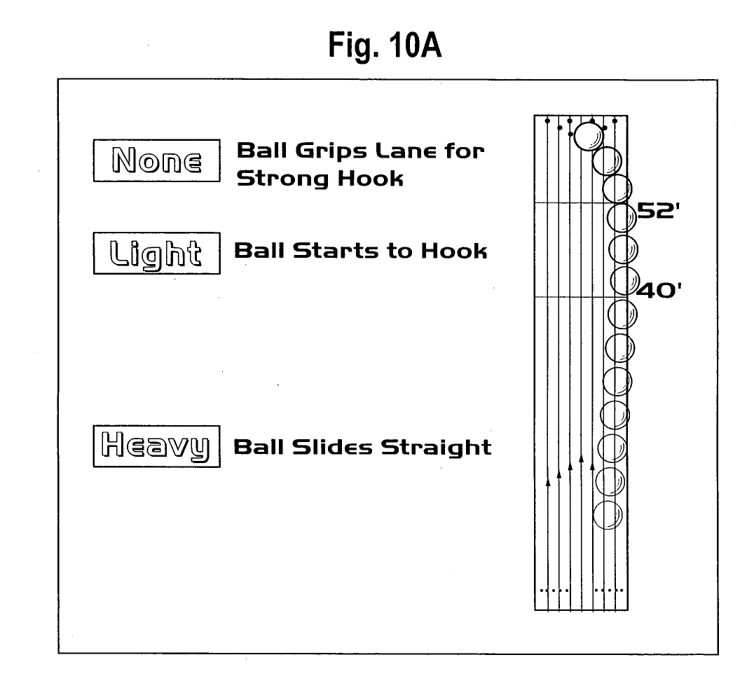

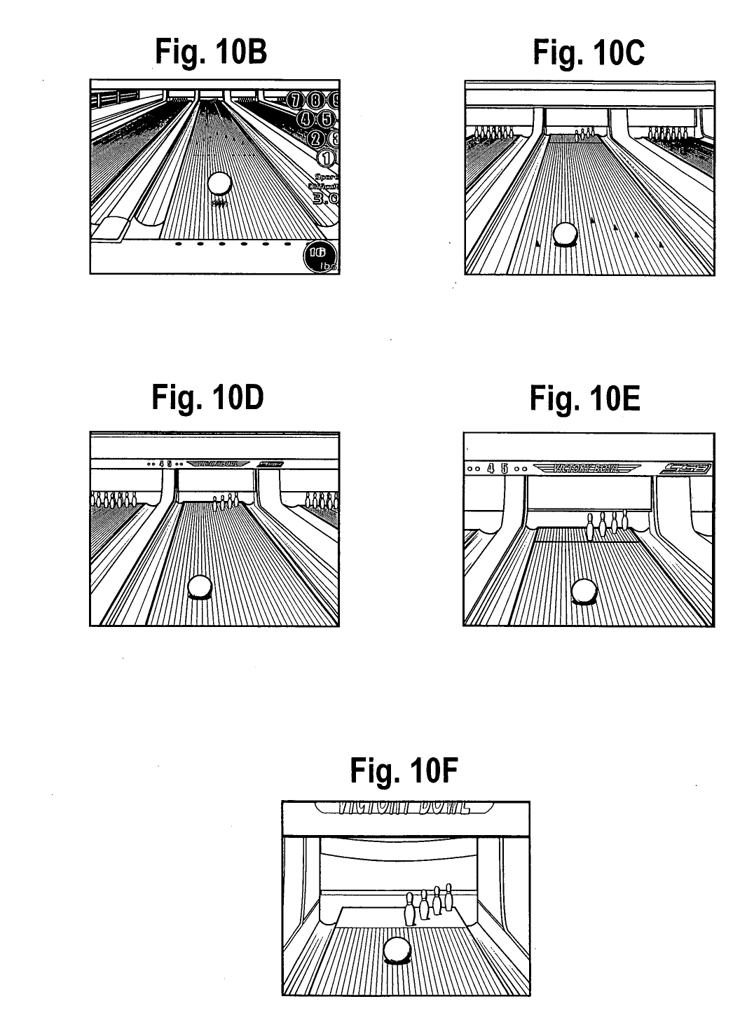

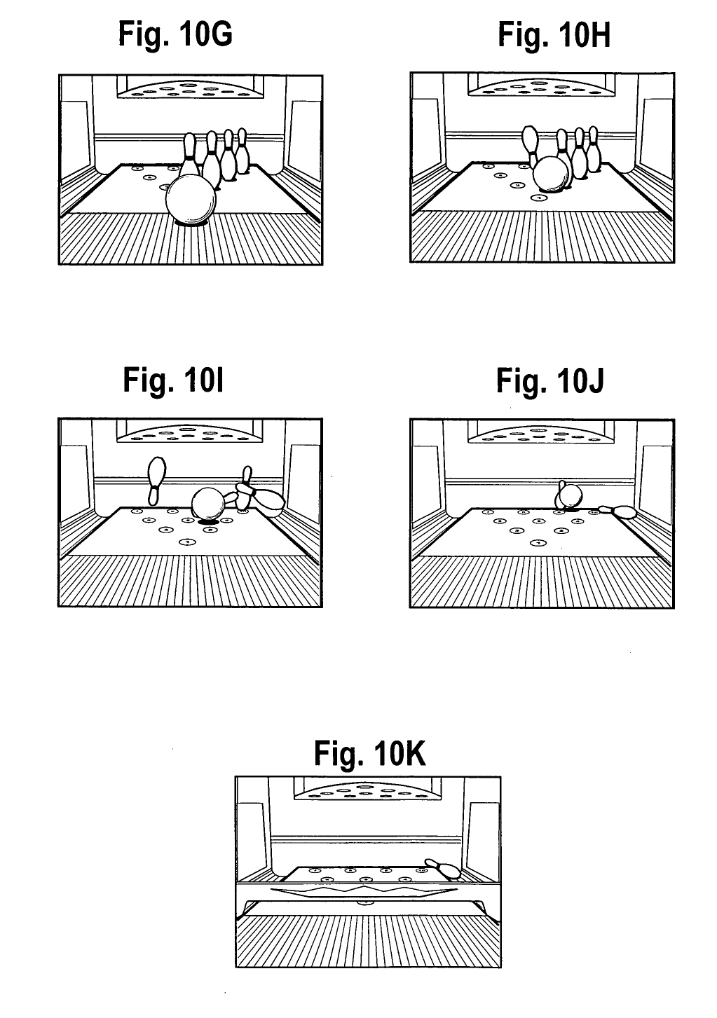

FIG. 9 illustrates a flow diagram 500 of Ball Rolling processing which displays the ball as rolling on the lane additionally taking into account lane characteristics, such as a profile of the oil present on the lane. Images of the ball rolling on the lane are sequentially presented in a sequence of frames as illustrated in FIGS. 10B-10K. Each cycle through processing 500 corresponds to a displayed ball rolling frame. It will be understood that all lob processing 200 (FIG. 4) and all throw processing 300, 400 (FIGS. 6, 8 respectively) has been completed before the Ball Rolling processing 500, FIG. 9 and presentation of an associated image sequence, such as in FIGS. 10B-10K, on display 16 is initiated.

Lane characteristics affect ball rolling behavior. FIG. 10A illustrates various exemplary ball behavior characteristics as a function of degrees of oil on the lane. In the presence of a heavy coating of oil, region 60-1, the ball can be expected to slide in a straight line. In a lighter region of oil 60-2 the ball can be expected to roll with a slight hook. In a non-oil region in the vicinity of the pins 60-3, the ball can be expected to grip the lane and exhibit a substantial hook. It will be understood that a variety of oil profiles could be stored and used in connection with a selected lane.

Processing 500 takes into account lane oil profiles. In a step 502, a selected profile can be represented by a prestored grid of oil indicating numbers. The profile can be evaluated relative to the location of the ball on the lane, step 506.

In a step 508 the profile can be adjusted as would be understood by those of skill in the art to take into account ball velocity since faster balls will slide through the oil while slower balls tend to grip the oil in the lane to a greater extent. The subject adjustment can take the form of an interaction multiplier which falls for example in a range of 0-2. The fastest balls can be assigned an interaction multiplier of zero. Slower balls have a higher interaction value between zero and two.

The oil value can be further adjusted, step 510 in view of the degree of hook with which the ball was delivered. For example where the degree of hook (angle between pull back and push forward) exceeds twelve degrees, the interaction multiplier can be further increased.

The adjusted oil profile value(s) is (are) supplied to the physics engine which determines the nature of the travel of the ball along the lane step 512. The corresponding frame is then presented on display 16, such as exemplary frames, FIGS. 10B-10K.

The process 500 is repeated sequentially as the ball travels down the lane for the creation of subsequently displayed frames until the Ball Rolling sequence 500 ends with the ball either falling into a gutter or colliding with the pins, see FIGS. 10-H-10J. Pin interactions subsequent to ball impact can be established by the physics engine and subsequently displayed. At that time, the score is updated, region 50a, and the bowler B reappears on the proximal end of the lane. Further processing and displays are in accordance with FIGS. 2, 3.

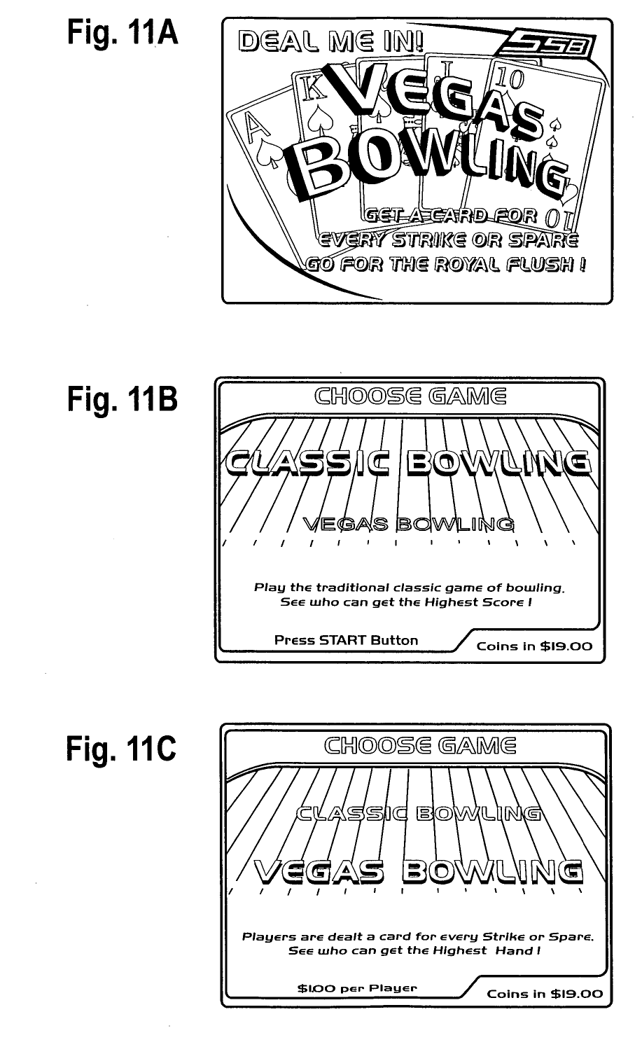

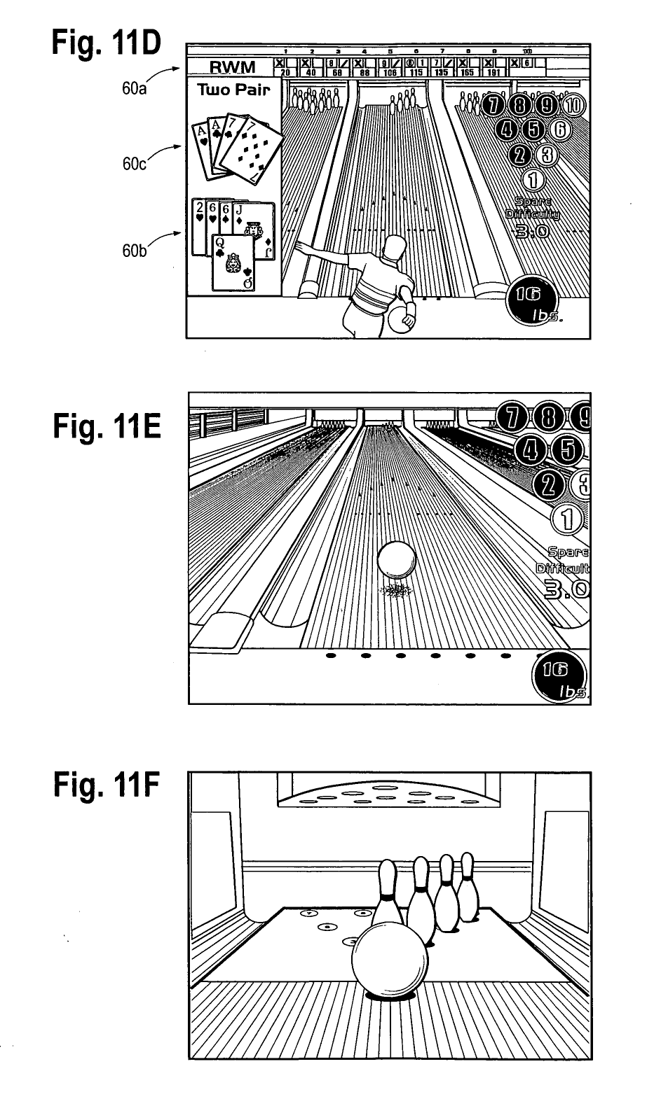

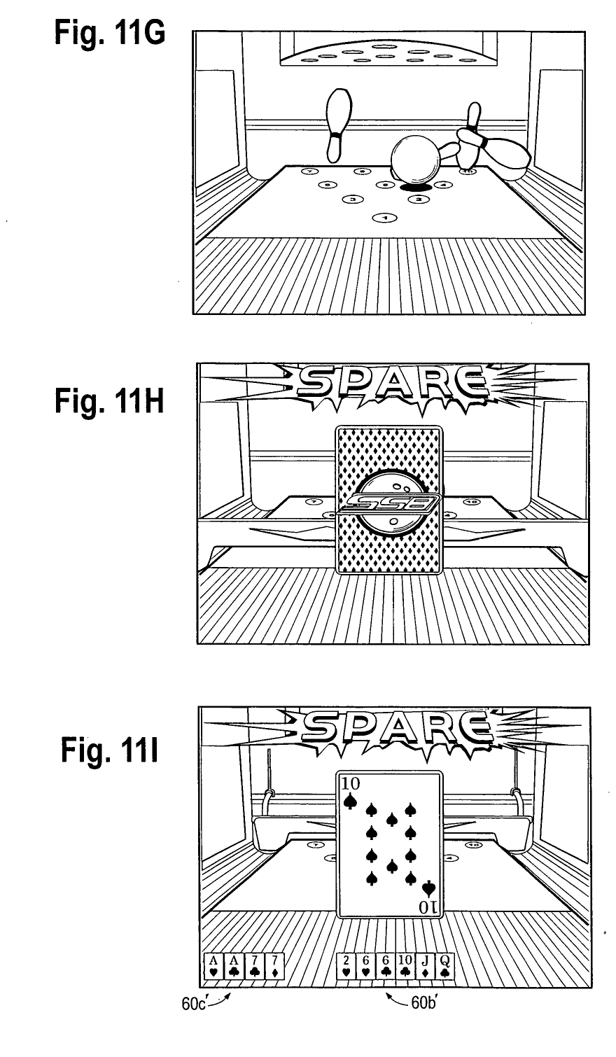

FIGS. 11A-11I taken together illustrate a sequence presented on display 16 of one form of a game-within-a-game. An attract sequence is presented in the screen of FIG. 11A. In FIGS. 11B, C, the player has an opportunity to choose between a standard bowling game and the indicated alternate.

Where the indicated alternate has been selected, FIGS. 11D-11I, players are dealt a card for every strike or spare that they achieve. In this regard, in FIG. 11D, the bowler's score line has been displayed across the top of the screen in a region generally indicated at 60a. All of the players cards presented in a region 60b. The players best hand is illustrated in region 60c.

In the event that the player achieves yet another spare, illustrated in screens 11E-11G, a spare indicating screen can be displayed, FIG. 11H. Finally, as illustrated in FIG. 11I, an additional card can be dealt to the player, based on a randomized distribution thereof. The last card expands the number of the player's cards, see region 60b′, but without changing the players best hand, see region 60c′. The next player up experiences a similar play sequence. Ultimately at the end of the game, the player with the highest hand wins.

It will be understood that other variations could be incorporated into the bowling sequence of FIGS. 11D-11I or used independently. For example, the pins of the bowling sequence of FIGS. 11D-11I can over a period of time after each strike or spare be replaced by a pin of a different color, for example, a silver pin. Ultimately, the player can be presented a rack of 10 silver pins and an opportunity to achieve a “silver strike”.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modification as fall with the scope of the claims.

1. A bowling video game comprising:
a manually manipulatable track ball,
a graphical display; and
circuitry coupled to the track ball and the display for visually presenting a bowling sequence with the circuitry responsive to at least first and second movements of the track ball to establish a direction of travel of a simulated bowling ball on the display.

2. A game as in claim 1 with the circuitry further responsive to a velocity characteristic from the track ball to establish a velocity of the simulated bowling ball.

3. A game as in claim 2 which includes executable instructions for presenting a plurality of bowling pins on the display.

4. A game as in claim 3 which includes additional instructions that display the bowling ball colliding with the pins on the display.

5. A game as in claim 4 which includes further instructions that display a post-collision image of at least some of the pins.

6. A game as in claim 5 which includes circuitry for displaying a game performance indicium.

7. A game as in claim 1 which includes instructions to determine from the first and second movements that the direction of travel of the bowling ball is one of straight, generally curved, or substantially straight with a hooked end region.

8. A game as in claim 7 with the software further responsive to a velocity characteristic from the track ball to establish a velocity of the simulated bowling ball.

9. A game as in claim 8 which includes instructions for presenting displays of repetitive travel of the bowling ball in response to repetitive movements of the track ball.

10. A game as in claim 1 where software responds to at least one pre-stored oil profile of a lane for determining, responsive to at least first and second movements of the track ball, travel of the bowling ball along the lane.

11. A method comprising:
displaying a representation of a bowling lane;
displaying a representation of a bowler located at a proximal end of the lane;
specifying a bowling ball weight;
providing manually generated back swing information and displaying a back swing by the bowler;
providing manually generated ball delivery information and displaying a delivery of a ball onto the lane;
displaying the ball rolling on the lane in accordance with both the backswing information and the ball delivery information; and
altering behavior of the ball in accordance with pre-stored lane conditions.

12. A method as in claim 11 which includes laterally off-setting the position of the bowler on the lane.

13. A method as in claim 11 with the information specifying both ball direction and ball velocity.

14. A method as in claim 11 which includes selecting a mode of play from a class which includes a game of bowling, league bowling and tournament bowling.

15. Bowling video game software comprising:
first software for graphically presenting a bowler at a proximal end of a bowling lane;
second software for processing transducer output signals to define arm movement of the bowler as well as ball travel along the lane.

16. Game software as in claim 15 which includes software to cause the ball to travel in at least one of a substantially straight line, a curve, or, a substantially straight line terminating in a hook.

17. Game play software as in claim 15 which includes software to modify ball travel in accordance with at least one pre-stored lane oil profile.

18. Game play software as in claim 15, responsive to player input, for locating the bowler laterally on the bowling lane.

19. Game play software as in claim 15, responsive to player input, to select a bowling ball weight from a predetermined weight range.

20. Game play software as in claim 15, responsive to player input, to enter one of a league play or a tournament play mode.

21. Game play software as in claim 15 where the second software responds to both ball direction and ball velocity related information from the transducer.

22. Game play software as in claim 21 which includes software to modify ball travel in accordance with at least one pre-stored lane oil profile.

23. Game play software as in claim 21 which includes software for graphically presenting a plurality of pins at a distal end of the lane.

24. Game play software as in claim 23 which includes software for graphically presenting travel of the ball through the pins.

25. A bowling video game comprising:
a manually manipulatable multi-dimensional transducer;
a graphical display; and
circuitry coupled to the transducer and the display for visually presenting a bowling sequence with the circuitry responsive to at least a first movement of the transducer to establish, at least in part, a direction of travel and a velocity of a simulated bowling ball on the display.

26. A game as in claim 25 which includes instructions to determine from first and second movements of the transducer that the direction of travel of the bowling ball is one of straight, generally curved, or substantially straight with a hooked end region.

27. A game as in claim 25 which includes a port for communicating game play information to a remote storage device.

28. A game as in claim 25 which includes circuitry enabling a user to select a weight for the bowling ball.

29. A game as in claim 25 which includes circuitry enabling a user to laterally locate a delivery location of the bowling ball on the display.

30. A game as in claim 25 which includes executable instructions which present a simulated bowling lane with pins located at a distal end thereof.

31. A game as in claim 30 which includes additional instructions to display a figure of a bowler at a proximal end of the lane.

32. A game as in claim 31 which includes executable instructions to link motion of the transducer to motion of a ball delivery arm of the bowler.

33. A video bowling game comprising:
first software, responsive to a first motion for determining a trajectory, airborn in part, for a bowling ball; and
second software for presenting a visual display of the bowling ball initially while airborn and subsequently when rolling on a simulated lane.

34. A game as in claim 33 which includes software responsive to first and second generally opposite motions to provide a path of travel of the ball after it has been released onto the lane.

35. A game as in claim 33 which includes software for establishing a velocity parameter in accordance with one of the motions.

36. A game as in claim 34 which includes additional software that incorporates a pre-stored lane oil grid into the path of travel thereby modifying the path of travel of the ball.

37. A video bowling game comprising:
a graphical display device;
first software to present an image of a bowler and a bowling alley;
second software, responsive to multi-dimensional manual inputs, to display a backswing and delivery of a bowling ball on the alley; and
third software to display the ball rolling on the alley toward a plurality of bowling pins.

38. A game as in claim 37 which includes circuitry for manually positioning the bowler laterally on the lane.

39. A game as in claim 37 which includes software to establish a ball velocity in accordance with the manual inputs.

40. A game as in claim 37 which includes circuitry to select a bowling ball weight.
